(19) United States
(12) Patent Application Publication
(10) Pub. No.: US 2013/0078500 A1
(43) Pub. Date: Mar. 28, 2013

(54) NON-AQUEOUS ELECTROLYTE SECONDARY BATTERY AND COMBINED BATTERY

(71) Applicants: Norio Takami, Yokohama-shi (JP); Hiroki Inagaki, Kawasaki-shi (JP); Takashi Kishi, Yokosuka-shi (JP)

(72) Inventors: Norio Takami, Yokohama-shi (JP); Hiroki Inagaki, Kawasaki-shi (JP); Takashi Kishi, Yokosuka-shi (JP)

(21) Appl. No.: 13/684,629

(22) Filed: Nov. 26, 2012

Related U.S. Application Data
(63) Continuation of application No. 12/805,815, filed on Aug. 20, 2010, now abandoned.
Application No. 12/805,815 is a continuation of application No. PCT/JP09/53999, filed on Feb. 25, 2009.

(30) Foreign Application Priority Data
Mar. 4, 2008 (JP) 2008-053745

(51) Int. Cl. H01M 2/20; H01M 2/30

(52) U.S. Cl. CPC H01M 2/202; H01M 2/30
USPC 429/158; 429/178

(57) ABSTRACT

According to one embodiment, a non-aqueous electrolyte secondary battery includes a metal container, an electrode group housed in the metal container and including a positive electrode, a negative electrode and a separator interposed between the negative and the positive electrodes, a non-aqueous electrolyte housed in the metal container, a positive electrode lead of which one end is electrically connected to the positive electrode, a negative electrode lead of which one end is electrically connected to the negative electrode, a negative electrode terminal attached to the metal container and electrically connected with the other end of the negative electrode lead, and an Sn alloy film interposed between the negative electrode lead and the negative electrode terminal. The Sn alloy film includes Sn and at least one metal selected from the group consisting of Zn, Pb, Ag, Cu, In, Ga, Bi, Sb, Mg and Al.

### CROSS-REFERENCE TO RELATED APPLICATIONS

This application is a Continuation application of U.S. application Ser. No. 12/805,815, filed Aug. 20, 2010, now pending; which is a Continuation application of PCT Application No. PCT/JP2009/053999, filed Feb. 25, 2009, which was published under PCT Article 21(2) in English.

This application is based upon and claims the benefit of priority from Japanese Patent Application No. 2008-053745, filed Mar. 4, 2008; the entire contents of which are incorporated herein by reference.

### FIELD

Embodiments described herein relate generally to a non-aqueous electrolyte secondary battery and to a combined battery.

### BACKGROUND

There are many expectations as regards use of non-aqueous electrolyte batteries using a lithium metal, lithium alloy, lithium compound or carbonaceous material as the negative electrode as high-energy density batteries and high-output density batteries, and such batteries are being studied and developed enthusiastically. Lately, lithium ion batteries provided with a positive electrode containing LiCoO₂ or LiMn₂O₄ as an active material and with a negative electrode containing a carbon material which absorbs and desorbs lithium have been widely put to practical use so far. Also, with regard to the negative electrode, studies are being made as to metal oxides and alloys which are to be used in place of the carbon material.

Conventionally, the current collector of a negative electrode which is usually used is formed of a copper foil, and a lead and a terminal to which this lead is connected are formed of copper or nickel. In a secondary battery provided with a negative electrode containing a current collector made of a copper foil, the potential of the negative electrode is raised when it is put in an overcharged state. Due to this, the solubilization reaction of the negative electrode made of a copper foil is promoted, leading to a rapid reduction in discharge capacity. In a combined battery provided with two or more of the secondary batteries, the balance between the capacities of these batteries is destroyed, which causes some batteries to enter an overcharged state when a long cycle is continued. This gives rise to the problem that the current collector made of a copper foil is solubilized. As measures to deal with this problem, each secondary battery is provided with a protective circuit to prevent the battery from entering an overcharged state. However, the secondary battery provided with the protective circuit is decreased in energy density corresponding to the volume of the protective circuit.

Also, as the metal container, for example a metal can having a small wall thickness is used to make a container lighter in weight. When a secondary battery comprising a metal can having a thin wall is put in an overcharged state as mentioned above, the current collector of the negative electrode, i.e., the lead and copper terminal materials are dissolved, leading to an increase in the swelling of the battery.

### BRIEF DESCRIPTION OF THE DRAWINGS

FIG. 1 is a sectional view showing a square-shaped non-aqueous electrolyte secondary battery according to an embodiment;

FIG. 2 is a sectional view along the line across a negative terminal of a secondary battery shown in FIG. 1;

FIG. 3 is a perspective view showing a flattened wound electrode group housed in a metal container shown in FIG. 1;

FIG. 4 is a front view showing another form of a negative electrode terminal used in a flat type non-aqueous electrolyte battery according to an embodiment;

FIG. 5 is a perspective view showing another form of a negative electrode lead used in a flat type non-aqueous electrolyte battery according to an embodiment; and

FIG. 6 is a perspective view showing a combined battery according to an embodiment.

### DETAILED DESCRIPTION

Next, the non-aqueous electrolyte battery according to this embodiment will be described in detail.

In general, according to an embodiment, a non-aqueous electrolyte secondary battery comprises a metal container; an electrode group housed in the metal container and comprising a positive electrode, a negative electrode having an active material which absorbs lithium ions at a potential higher by 0.4 V or more than the electrode potential of lithium and a separator interposed between the negative electrode and the positive electrode; a non-aqueous electrolyte housed in the metal container; a positive electrode lead of which one end is electrically connected to the positive electrode; a negative electrode lead of which one end is electrically connected to the negative electrode; a positive electrode terminal attached to the metal container and electrically connected with the other end of the positive electrode lead; a negative electrode terminal attached to the metal container and electrically connected with the other end of the negative electrode lead; and a conductive film interposed between the negative electrode lead and the negative electrode terminal, wherein the conductive film is capable of melting when the conductive film is heated to or beyond a temperature of a melting point thereof by an electric current flowing through the conductive film.

The negative electrode lead and the negative electrode terminal are electrically connected each other with the conductive film. The conductive film is capable of melting when the conductive film is heated to or beyond a temperature of the melting point thereof by an electric current flowing through the conductive film. That is, when, for example, an excessive electric current flows towards the negative electrode lead through the conductive film from the negative electrode terminal, the conductive film is heated by Joule heat which is generated an interface between the negative electrode terminal and the conductive film and an interface between the conductive film and the negative electrode lead. If, the heating temperature of the conductive film becomes equal to or beyond its melting point, the conductive film is melded. The excessive electric current flows when external short circuits of the battery occur or internal short circuits of the combined battery in the case of parallel connection occur. The melting of the conductive film releases connection between the negative electrode lead and the negative electrode terminal. In other words, the connection between the negative electrode lead and the negative electrode terminal is broken, whereby an electric current flow between the negative electrode lead and the negative electrode terminal is cut off.

In a preferred embodiment, the negative electrode lead and the negative electrode terminal are electrically connected each other with an Sn alloy film which is interposed between the negative electrode lead and the negative electrode terminal. The Sn alloy film contains Sn and at least one metal selected from the group consisting of Zn, Pb, Ag, Cu, In, Ga, Bi, Sb, Mg and Al.

The above negative electrode, positive electrode, separator, non-aqueous electrolyte and metal container will be described in detail.

1) Negative Electrode

The negative electrode comprises a current collector, and a negative electrode layer formed on one or both surfaces of the current collector and containing an active material, a conductive agent and a binder.

The current collector is made of an aluminum foil having a purity of 99.99% or more or an aluminum alloy foil. The aluminum alloy is preferably an alloy containing a metal such as Mg, Zn, Mn or Si. The aluminum alloy preferably contains a transition metal such as Fe, Cu, Ni and Cr in an amount of 100 ppm or less, as well as the metals.

The average size of crystal particles in the aluminum foil or aluminum alloy foil is preferably 50 μm or less and more preferably 10 μm or less. Here, the average particle diameter of crystal particles in the aluminum foil or aluminum alloy foil means the average diameter of the particles as calculated by the following method. The structure of the surface is observed by a metal microscope to count the number n of crystal particles existing in an area of 1 mm×1 mm, thereby calculating the average area of the crystal particles according to the following equation: S=(1×10⁶)/n (μm²). Specifically, in the observation using a metal microscope, the number of crystal particles is counted in five places. The average area of the crystal particles is substituted in the following equation (1) to find the diameter d (μm) and also to calculate an average of the diameters, thereby finding the average diameter d (μm) of the crystal particles. Here, an error in calculating the diameter is expected to be around 5%.

d=2(S/π)^{1/2} (1)

The size of crystal particles in an aluminum foil or aluminum alloy foil is affected by many factors, including the material composition, impurities, processing conditions, heat treatment histories, and heating condition and cooling condition of annealing. For this, an aluminum foil or aluminum alloy foil with crystal particles having an average diameter of 50 μm or less can be produced by organically combining the various factors to adjust them in the production process. In this case, the current collector may be produced by use of PACAL21 (trade name, manufactured by Nippon Foil Mfg Co., Ltd.).

The current collector formed from an aluminum foil or aluminum alloy foil with crystal particles having an average diameter of 50 μm or less can be outstandingly increased in strength. The increase in the strength of the current collector improves the physical and chemical resistance of the current collector, which offers a resistance against rupture of the current collector. In an overcharge long-term cycle under a high-temperature environment (40° C. or more), because the current collector can significantly prevent deterioration caused by dissolution and corrosion, the resistance of the negative electrode can be suppressed. Moreover, suppression of the resistance in the negative electrode reduces the Joule heat generated, enabling the heat generation of the negative electrode to be suppressed.

The current collector formed from an aluminum foil or aluminum alloy foil with crystal particles having an average diameter of 50 μm or less can suppress a deterioration caused by dissolution and corrosion resulting from the intrusion of water in a long-term cycle under a high-temperature and high-humidity environment (40° C. or more and a humidity of 80% or more).

Moreover, when a negative electrode is produced by suspending an active material, a conductive agent and a binder in a proper solvent and by applying this suspension to the current collector, followed by drying and pressing, the current collector has high strength. Therefore, if the pressure of the pressing is raised, the rupture of the current collector can be prevented. As a result, a negative electrode having high density can be produced, making it possible to improve the volumetric density. Also, the improvement in the density of the negative electrode brings about an increase in heat conductivity, so that the heat radiation ability of the negative electrode can be improved. In addition, the non-aqueous electrolyte battery can be limited in the rise of temperature by the synergetic effect of the limitation to heat generation and the improvement in the heat radiation ability of the negative electrode.

The thickness of the current collector is preferably 20 μm or less.

The active material absorbs lithium ions at a potential higher by 0.4 V or more than the electrode potential of lithium. Specifically, the potential of an open circuit when the active material absorbs lithium ions is higher by 0.4 V than the potential of an open circuit of a lithium metal. The phenomenon of micronization caused by an alloying reaction between aluminum and lithium can be suppressed by using the negative electrode containing such an active material even if a current collector, lead and terminal around the negative electrode are made from low resistance aluminum (or aluminum alloy). Also, the non-aqueous electrolyte secondary battery provided with the negative electrode can be further raised in voltage. Particularly, the open circuit potential when the active material absorbs lithium ions is higher by, preferably, 0.4 to 3 V and more preferably 0.4 to 2 V than the open circuit potential of a lithium metal.

As the active material, for example, metal oxides, metal sulfides, metal nitrides or metal alloys which absorb lithium ions at the potential specified above may be used. Examples of the metal oxides include tungsten oxides (WO₃), amorphous tin oxides such as SnB_{0.4}P_{0.6}O_{3.1}, tin silicon oxides (SnSiO₃) and silicon oxide (SiO). Examples of the metal sulfides include lithium sulfide (TiS₂), molybdenum sulfide (MoS₂) and iron sulfide (FeS, FeS₂ and, LixFeS₂). An example of the metal nitrides is lithium cobalt nitride (LiₓCo_{y}N, 0<x<4.0, 0<y<0.5).

The active material is preferably titanium-containing oxides such as titanium-containing metal composite oxides and titanium type oxides.

As the titanium-containing metal composite oxides, titanium type oxides containing no lithium when these oxides are synthesized, lithium-titanium oxides and lithium-titanium composite oxides obtained by substituting a hetero-element for a part of the structural elements of the lithium-titanium oxides may be used. As the lithium-titanium oxides, for example, lithium titanate having a spinel structure (for example, Li₄₊ₓTi₅O₁₂ (0<x≦3) or ramsdellite lithium titanate (for example, Li_{2+y}Ti₃O₇ (0≦y≦3) may be used. These lithium titanates absorb lithium ions at a potential higher by about 1.5 V than the electrode potential of lithium and are therefore materials electrochemically very stable to a current collector of an aluminum foil or aluminum alloy foil.

As the titanium type oxides, for example, TiO₂ or metal composite oxides containing Ti and at least one element selected from Ti, P, V, Sn, Cu, Ni, Co and Fe may be used. Preferable examples of TiO₂ include TiO₂ (B) or anatase type TiO₂ which are heat-treated at 300 to 500° C. and have less crystallinity. As the metal composite oxides containing Ti and at least one element selected from Ti, P, V, Sn, Cu, Ni, Co and Fe, for example, TiO₂—P₂O₅, TiO₂—V₂O₅, TiO₂—P₂O₅—SnO₂ or TiO₂—P₂O₅—MeO (Me is at least one element selected from the group consisting of Cu, Ni, Co and Fe) may be used. The metal composite oxide preferably has a microstructure in which a crystal phase and an amorphous phase coexist or a microstructure in which an amorphous phase singly exists. A non-aqueous electrolyte secondary battery provided with a negative electrode containing a metal composite oxide having such a microstructure can be remarkably improved in cycle performance. Among these materials, lithium titanium oxides or metal composite oxides containing Ti and at least one element selected from Ti, P, V, Sn, Cu, Ni, Co and Fe are preferable.

In the active material, the average particle diameter of primary particles is preferably 1 μm or less and more preferably 0.3 μm or less. Here, the particle diameter of the active material may be measured using a laser diffraction type grain distribution measuring device (trade name: SALD-300, manufactured by Shimadzu Corporation) according to the following method. Specifically, about 0.1 g of a sample (active material), a surfactant and 1 to 2 mL of distilled water are added in a beaker and the mixture is thoroughly stirred. The slurry obtained after the stirring is completed is poured into a stirring water tank to measure the distribution of light intensity 64 times at intervals of 2 seconds by using the laser diffraction type grain distribution measuring device. The obtained data of the grain distributions are analyzed thereby to find the average particle diameter of primary particles of the active material.

The active material having an average primary particle diameter of 1 μm or less may be obtained either by making an active material into a powder 1 μm or less in size when subjecting an active material raw material to reaction synthesis or by crushing a powder material obtained after a baking treatment, into particles 1 μm in size by using a ball mill or jet mill.

A non-aqueous electrolyte secondary battery provided with a negative electrode containing an active material including primary particles having an average particle diameter of 1 μm or less can be improved in cycle performance. Particularly, as this secondary battery exhibits excellent cycle performance when it is rapidly charged or discharged at high output, it is most suitable to secondary batteries for vehicles which require a high input/output performance. Specifically, in the case of the active material which absorbs and desorbs lithium ions, the specific surface area of secondary particles, which are coagulates of primary particles, rises with the lowering of the average particle diameter of the primary particles. As a result, an active material with secondary particles having a large specific surface area can absorb and desorb lithium ions promptly because the distance of diffusion of lithium ions inside the active material is shortened.

Also, in the production of the negative electrode, a load on the current collector in the aforementioned pressing step rises with the lowering of the average particle diameter of primary particles of the active material. For this reason, a current collector formed of an aluminum foil or aluminum alloy foil is broken in the pressing step, leading to a reduction in the performance of the negative electrode. However, a current collector formed using the aluminum foil or aluminum alloy foil with crystal particles having an average particle diameter of 50 μm or less is improved in strength. Therefore, even if an active material having an average primary particle diameter of 1 μm or less is used to manufacture the negative electrode, the breakdown of the current collector in this pressing step is avoided and therefore, the reliability and cycle performance in rapid charging and high-output discharging can be improved.

As the conductive agent, for example, carbon materials may be used. As the carbon material, for example, acetylene black, carbon black, coke, carbon fiber or graphite may be used.

As the binder, for example, a polytetrafluoroethylene (PTFE), polyvinylidene fluoride (PVdF), fluoro-rubber or styrene butadiene rubber may be used.

With regard to the ratios of the active material, conductive agent and binder to be compounded, it is preferable that the active material is 80 to 95% by weight, the conductive agent is 3 to 20% by weight and the binder is 2 to 7% by weight.

The lead electrically connected to the current collector of the negative electrode is preferably made of aluminum having a purity of 99% or more and an aluminum alloy. The aluminum preferably has a purity of 99.9% or more. The aluminum alloy preferably has a composition containing, for example, Mg, Fe and Si in a total amount of 0.7% by weight or less and balanced substantially with aluminum.

The lead is preferably a flexible foil or plate having a thickness of 100 to 500 μm and a width of 2 to 20 mm. Such a lead is free from a dissolution reaction in an electrolyte solution in an overcharged state, and also free from wire breakage when oscillated for a long time, allowing the flow of a large current. For this reason, a secondary battery having this negative electrode lead can retain long-term reliability and high output performance.

The negative electrode terminal is made of, for example, a metal selected from the group consisting of Cu, Fe, Al, Ni, and Cr. The negative electrode terminal is preferably made of an aluminum alloy containing copper and other metal components and having a purity of less than 99%. Copper is reduced in resistance and is therefore desirable. The aluminum alloy having a purity of less than 99% can be more increased in strength and corrosion resistance than aluminum having a purity of 99% or more and an aluminum alloy having a purity of 99% or more. Among the metal components, Mg and Cr can improve the corrosion resistance of the aluminum alloy. Among the metal components, Mn, Cu, Si, Fe and Ni can improve the strength of the aluminum alloy.

Any material may be used as the conductive film interposed between the negative electrode lead and the negative electrode terminal insofar as it is melted by Joule heat generated between the negative electrode lead and the negative electrode terminal. The conductive film may be made of, for example, an Sn alloy, Pd alloy or In alloy. When the negative electrode lead is connected to the negative electrode terminal with such a conductive film interposed therebetween, the conductive film is melted by the Joule heat generated between the negative electrode lead and the negative electrode, thereby releasing the connection between the negative electrode lead and the negative electrode terminal.

The conductive film is preferably made of an Sn alloy containing Sn and at least one metal selected from the group consisting of Sn, Zn, Pb, Ag, Cu, In, Ga, Bi, Sb, Mg and Al. The ratio of each metal in this Sn alloy to be formulated is as follows: Sn is preferably 70 to 95% by weight and the metal is preferably 5 to 30% by weight. An Sn alloy having a melting point of 250° C. or less and more preferably 180 to 220° C. is preferable.

The alloy (for example, Sn alloy) used for the conductive film is electrochemically alloyed with lithium in the case of using a conventional negative electrode containing carbon as the active material. It is therefore difficult to provide a good connection between the negative electrode lead electrically and the negative electrode terminal. The non-aqueous electrolyte secondary battery according to this embodiment uses the negative electrode containing an active material which absorbs lithium ions at a potential higher by 0.4 V or more than the electrode potential of lithium. Therefore, a conductive film made of the alloy is not electrochemically alloyed with lithium, but can surely connect the negative electrode lead electrically to the negative electrode terminal.

The above conductive film (for example, Sn alloy film) is interposed between the negative electrode lead and the negative electrode terminal in the form shown below.

1) The Sn alloy film is an Sn alloy foil and this Sn alloy foil is bound with the negative electrode lead and negative electrode terminal such that it is sandwiched between the negative electrode lead and the negative electrode terminal. The connection of the negative electrode lead with the Sn alloy foil or the negative electrode terminal is achieved by welding, preferably ultrasonic welding.

2) The Sn alloy film is formed on at least one of a portion of the negative electrode lead to which the negative electrode terminal is connected and a portion of the negative electrode terminal to which the negative electrode lead is connected. As the methods for forming the Sn alloy film, a plating method or a sputtering method may be adopted. The Sn alloy film formed on the portion of the negative electrode lead, to which the negative electrode terminal is connected, is joined to the negative electrode terminal by welding, preferably ultrasonic welding. Similarly, the Sn alloy film formed on the portion of the negative electrode terminal to which the negative electrode lead is connected is joined to the negative electrode lead by welding, preferably ultrasonic welding.

When the materials of the negative electrode lead and negative electrode terminal are aluminum and an aluminum alloy, respectively, the ultrasonic welding can join these members to the Sn alloy film surely and can therefore reduce the connection resistance between them.

The thickness of the conductive film such as the Sn alloy film is preferably 0.01 to 1 mm. When the thickness of the conductive film exceeds 1 mm, there is a fear that the time required for melting the conductive film is increased when, for example, an over current flows into the negative electrode lead from the negative electrode terminal. When the thickness of the conductive film is less than 0.01 mm, the mechanical strength at the junction between the negative electrode lead and the negative electrode terminal is possibly reduced.

The negative electrode terminal is preferably attached to the metal container in such a manner as to be electrically insulated from the metal container. The negative electrode terminal is preferably in the shape of a bolt having a diameter of 3 to 30 mm. In such a structure, the positive electrode terminal is preferably attached to the metal container in such a manner as to be electrically connected to the metal container and the other end of the positive electrode lead is preferably connected electrically to the positive electrode terminal through the metal container.

When, in such a structure, an over electric current flows into the negative electrode lead from the negative electrode terminal, Joule heat is generated at an interface between the negative electrode terminal and the negative electrode lead, while the positive electrode lead directly connected to the metal container also generates Joule heat at an interface between the positive electrode lead and the metal container. The Joule heat generated in the interface between the positive electrode lead and the metal container is diffused and radiated through the metal container which has a relatively large area. On the other hand, since the Joule heat generated between the negative electrode terminal and the negative electrode lead is locally occurred, the generated heat stays at these connecting portions. For this reason, the influence of the heat generated between the negative electrode terminal and the negative electrode lead along with the generation of Joule heat becomes much larger than that of the heat generated the interface between the metal container and the positive electrode lead. As a result, the conductive film, for example, the Sn alloy film, interposed between the negative electrode lead and the negative electrode terminal is placed in a state where it is melted easily. Therefore, the connection between the negative electrode lead and the negative electrode terminal is rapidly cut off by melting the Sn alloy film, whereby the electric current flow between the negative electrode lead and the negative electrode terminal is interrupted. Consequently, a rise in the temperature of the secondary battery can be suppressed rapidly.

When the positive electrode lead is electrically connected directly to the metal container, the positive electrode lead may be connected to any position of the metal container.

2) Positive Electrode

The positive electrode comprises a current collector and a positive electrode layer formed on one or both surfaces of the current collector and containing an active material, a conductive agent and a binder.

The current collector is made of an aluminum foil or an aluminum alloy foil. The aluminum foil or aluminum alloy foil preferably includes crystal particles having an average diameter of, preferably, 50 μm or less and more preferably 10 μm or less, similarly to the negative electrode current controller. A current collector formed from an aluminum foil or aluminum alloy foil with such crystal particles having an average diameter of 50 μm or less can be outstandingly increased in strength. Therefore, when the active material, conductive agent and binder are suspended in a proper solvent and this suspension is applied to the current collector, dried and pressed to manufacture a positive electrode, the current collector can be prevented from being broken even if the pressing pressure is increased. As a result, a high-density positive electrode can be manufactured and the volumetric density can be improved.

The current collector preferably has a thickness of 20 μm or less.

As the active material, for example, oxides, sulfides or polymers may be used.

As the oxides, for example, manganese oxide (MnO₂), iron oxide, copper oxide, nickel oxide, lithium-manganese composite oxide (for example, LiₓMn₂O₄ or LiₓMnO₂), lithium-nickel composite oxide (for example, LiₓNiO₂), lithium-cobalt composite oxide (for example, LiₓCoO₂), lithium-nickel-cobalt composite oxide (for example, LiₓNi_{1-y}Co_{y}O₂), lithium-nickel-manganese-cobalt composite oxide (for example, LiₓCo_{1-y-z}Mn_{y}Ni_{z}O₂), spinel type lithium-manganese-nickel composite oxide (for example, LiₓMn_{2-y}Ni_{y}O₄), lithium-phosphorous oxide having an olivin structure (for example, LiₓFePO₄, LiₓFe_{1-y}Mn_{y}PO₄ and LiₓCoPO₄), iron sulfate (Fe₂(SO₄)₃) or vanadium oxide (for example, V₂O₅) may be used. In the formulae, the following relations are preferably established between x, y and z: 0<x≦1, 0<y≦1, and 0<z≦1, unless otherwise noted. The above lithium-nickel-cobalt-manganese composite oxide preferably has a composition represented by LiₐNi_{b}Co_{c}Mn_{d}O₂ (wherein the mol ratios a, b, c and d are as follows: 0≦a≦1.1, 0.1≦b≦0.5, 0≦c≦0.9 and 0.1≦d≦0.5).

As the polymer, for example, conductive polymer materials such as a polyaniline and polypyrrole and disulfide type polymers may be used. Also, sulfur (S) and fluorocarbon may be used as an active material.

Preferable examples of the active material include lithium-manganese composite oxide, lithium-nickel composite oxide, lithium-cobalt composite oxide, lithium-nickel-cobalt composite oxide, spinel type lithium-manganese-nickel composite oxide, lithium-manganese-cobalt composite oxide and lithium ironphosphate, each of which provide a high battery voltage, and lithium-nickel-cobalt-manganese composite oxide having a layer crystal structure.

As the conductive agent, for example, acetylene black, carbon black or graphite may be used.

As the binder, a polytetrafluoroethylene (PTFE), polyvinylidene fluoride (PVdF) or fluoro rubber may be used.

With regard to the ratios of the active material, conductive agent and binder to be compounded, it is preferable that the active material is 80 to 95% by weight, the conductive agent is 3 to 20% by weight and the binder is 2 to 7% by weight.

3) Separator

As the separator, a nonwoven fabric made of cellulose, a synthetic resin or the like, polyethylene porous film, polypropylene porous film or alamide porous film may be used. The above nonwoven fabric made of cellulose is stable without being shrunk at a temperature as high as 160° C. or more and is therefore preferable.

4) Nonaqueous Electrolyte

As this non-aqueous electrolyte, for example, a liquid non-aqueous electrolyte prepared by dissolving an electrolyte in an organic solvent, a gel-like non-aqueous electrolyte obtained by making a composite of the liquid electrolyte and a macromolecular material or a solid non-aqueous electrolyte obtained by making a composite of a lithium salt electrolyte and a macromolecular material may be used. Also, a cold molten salt (ionic molten body) containing lithium ions may be used as the non-aqueous electrolyte.

The liquid aqueous electrolyte is prepared by dissolving an electrolyte in a concentration of 0.5 to 3 mol/L in an organic solvent.

As the electrolyte, at least one compound selected from LiBF₄, LiPF₆, LiAsF₆, LiClO₄, LiCF₃SO₃, LiN(CF₃SO₂)₂, LiN(C₂F₅SO₂)₃C and LiB[(OCO)₂]₂ may be used. Among these electrolytes, LiBF₄ is preferable because it is superior in thermal and chemical stability and has such a nature that it is resistant to decomposition though it is less resistant to corrosion.

As the organic solvent, cyclic carbonates such as propylene carbonate (PC) and ethylene carbonate (EC); chain carbonates such as diethyl carbonate (DEC), dimethyl carbonate (DMC) and methyl ethyl carbonate (MEC); chain ethers such as dimethoxy ethane (DME) and diethoxy ethane (DEE); cyclic ethers such as tetrahydrofuran (THF) and dioxolan (DOX); or γ-butyrolactone (GBL), acetonitrile (AN) or sulfolane (SL) may be used. These organic solvents may be either singly or in combinations of two or more.

As the macromolecular materials, for example, a polyvinylidene fluoride (PVdF), polyacrylonitrile (PAN) and polyethylene oxide (PEO) may be used.

The above cold molten salt (ionic molten body) contains lithium ions, organic cations and organic anions and is put into a liquid state at 100° C. or less, and in some cases, at ambient temperature or less.

5) Metal Container

The metal container is preferably made of aluminum or an aluminum alloy from the viewpoint of weight lightening and corrosion resistance. The above aluminum or aluminum alloy is preferably constituted by crystal particles having an average particle diameter of 50 μm or less and more preferably 10 μm or less. The metal container made of aluminum or an aluminum alloy constituted by crystal particles having an average particle diameter of 50 μm or less can be outstandingly increased in strength, making it possible to reduce the wall thickness of the metal container. As a result, the metal container is improved in radiation ability, and therefore a rise in battery temperature can be limited. Also, since the wall thickness of the metal container can be reduced, the volume of the electrode group which includes the positive electrode, separator and negative electrode and is to be housed can be effectively increased. This makes it possible to improve the energy density, which leads to weight lightning and downsizing of a battery. These characteristics are suitable for batteries, for example, in-vehicle secondary batteries, which require a high-temperature condition and high energy density.

The aluminum alloy used for the metal container preferably contains at least one metal selected from Mg, Mn and Fe. The metal container constituted by such an aluminum alloy is more improved in strength, making it possible to reduce the wall thickness of the container to 0.3 mm or less.

In the flat type non-aqueous electrolyte battery according to the embodiment, for example, the negative electrode terminal and the positive electrode terminal may be respectively attached to the metal container in an electrically insulating manner.

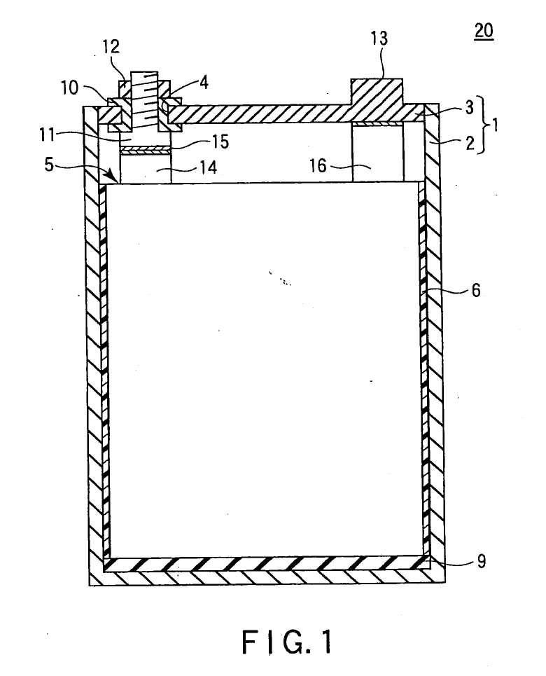

Next, the flat type non-aqueous electrolyte battery according to this embodiment will be described in detail with reference to FIGS. 1 to 3.

A flat type non-aqueous electrolyte battery 20 is provided with a metal container 1 constituted by, for example, an aluminum alloy. This metal container 1 is constituted by a metal can 2 having a bottomed rectangular cylinder form and a metal rectangular plate lid 3 bound airtightly to the top opening of the metal can 2 by, for instance, laser welding. This lid 3 is provided with a hole 4 opened to support a negative electrode terminal which will be described later.

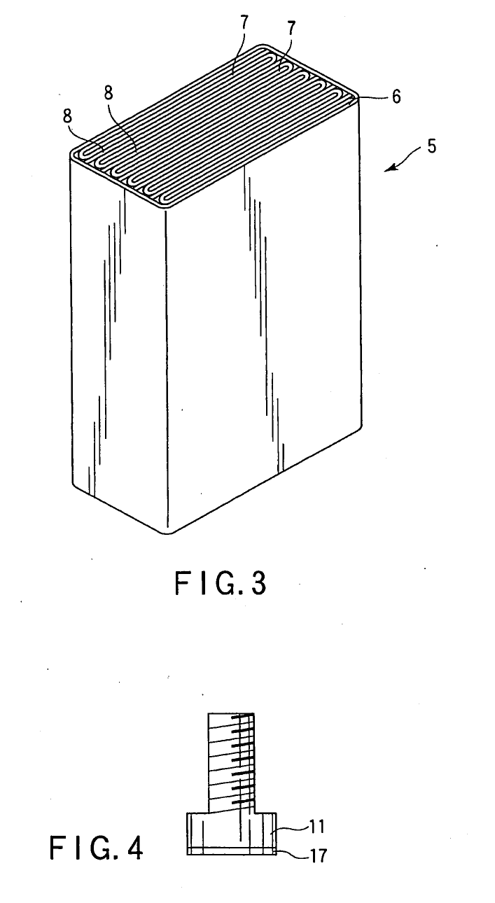

A flattened wound electrode group 5 is housed in the metal can 2 of the metal container 1. This flattened wound electrode group 5 has a structure in which, as shown in FIG. 3, plural negative electrodes 7 and plural positive electrodes 8 are alternately inserted between bent parts of the separator 6 folded in a zigzag manner and laminated, and the end part of the separator 6 is wound so as to cover the outside peripheral surface of the rectangular cylindrical laminate. The flattened wound electrode group 5 as explained above is inserted into and housed in the metal can 2 such that the surface of the separator folded in a zigzag manner constitutes the upper and lower end surfaces. An insulation plate 9 is disposed between the inside surface of the bottom of the metal can 2 and the lower end surface of the flattened wound electrode group 5. The non-aqueous electrolyte is housed in the metal can 2 where the flattened wound electrode group 5 is placed.

A cylindrical insulation member 10 having disk-like jaw parts on both ends is engaged in the hole 4 of the lid 3. A negative electrode terminal 11 having, for example, a bolt form is inserted into the cylindrical insulation member 10 such that its head is positioned inside the metal can 2 and its screw portion is projected outwards from the lid 3. A nut 12 made of, for example, an aluminum alloy, is screw-fitted to the projected screw portion of the negative electrode terminal 11 through a washer (not shown) made of an aluminum alloy to secure the negative electrode terminal 11 to the lid 3 in an electrically insulating manner. The above negative electrode terminal 11 is formed of an aluminum alloy which contains at least one metal selected from Mg, Cr, Mn, Cu, Si, Fe and Ni and has an aluminum purity of less than 99% by weight.

The cylindrical positive electrode terminal 13 made of, for example, an aluminum alloy is integrally projected from the upper surface of the lid 3 apart from the negative electrode terminal 11.

One end of a negative electrode lead 14 constituted by plural foils or plates is connected to each negative electrode 7 of the flattened wound electrode group 5 by, for example, ultrasonic welding and the other ends are collectively connected to the lower end surface of the negative electrode terminal 12 through an Sn alloy foil 15 by ultrasonic welding. Similarly to the negative electrode lead 14, one end of a positive electrode lead 16 constituted by plural foils and plates is connected to each positive electrode 8 of the flattened wound electrode group 5 by, for example, resistance welding and the other ends are collectively connected to the underside (inner surface) of the lid 3 to which the positive electrode terminal 13 is formed, by resistance welding. The negative electrode lead 14 and the positive electrode lead 16 are made of aluminum having a purity of 99% by weight or more and an aluminum alloy having a purity of 99% by weight or more, respectively.

The negative electrode terminal 11 is not limited to the structure which is produced using an aluminum alloy having the composition. For example, the negative electrode terminal 11 may have a structure in which the entire peripheral surface of a bolt-like mother body (terminal body) made of at least one metal selected from copper, iron and nickel is coated with an aluminum alloy layer which contains at least one metal selected from the group consisting of Mg, Cr, Mn, Cu, Si, Fe and Ni and has an aluminum purity of less than 99%, or a structure in which the surface (lower end surface) of the same bolt-like mother body (terminal body) to which surface the lead is connected is coated with the same aluminum alloy layer.

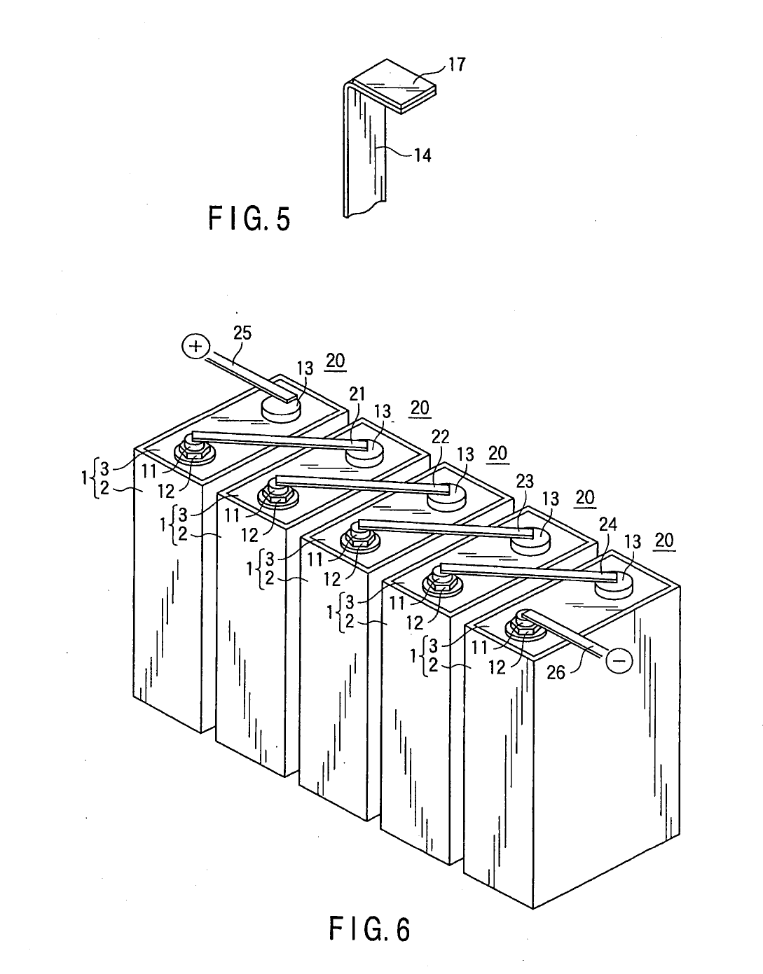

For example, in the connection of the negative electrode lead 14 with the negative electrode terminal 11, an Sn alloy film 17 may be formed on the connecting part of the negative electrode terminal 11 and the negative electrode lead, that is, the underside of the negative electrode terminal 11 in advance by a plating method or sputtering method and then, the negative electrode lead may be connected to the negative electrode terminal 11 with the Sn alloy film 17 which is interposed between these parts 11 and 14 by ultrasonic welding as shown in FIG. 4. Also, in the connection of the negative electrode terminal 11 with the negative electrode lead 14, an Sn alloy film 17 may be formed on the connecting part of the negative electrode terminal 11 and the negative electrode lead 14, that is, the surface of the vicinity of the top end of the negative electrode lead 14 by a plating method or sputtering method, and then the negative electrode lead 14 may be connected to the negative electrode terminal with the Sn alloy film 17 which is interposed between these parts 11 and 14 by ultrasonic welding as shown in FIG. 5.

Though the electrode group is so designed that plural negative electrodes and positive electrodes are alternately inserted between the bent parts of the separator folded in a zigzag manner and laminated, the electrode group is not limited to such a structure. The electrode group may have, for example, a flat spiral structure obtained by interposing a band separator between negative electrodes disposed like a band and positive electrodes disposed like a band and by spirally coiling these parts, followed by press-molding.

Next, a combined battery according to an embodiment of the present invention will be described.

In general, according one embodiment, a combined battery comprises a plurality of the non-aqueous electrolyte secondary batteries each the aforementioned, the batteries being electrically connected with each other in series, in parallel, or in series and parallel.

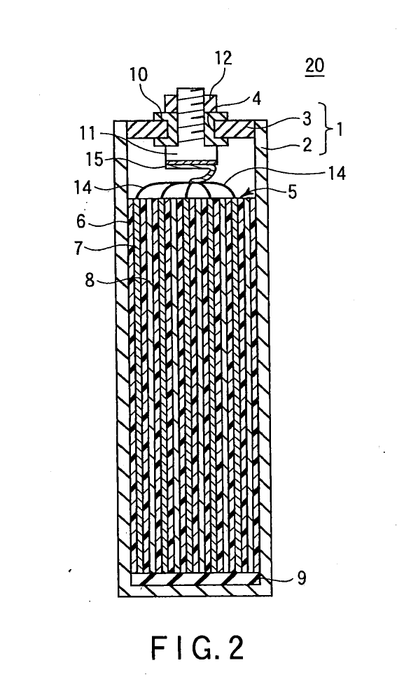

The combined battery according to the embodiment will be described in detail with reference to FIG. 6. This combined battery is provided with two or more, for example, five of the flat type non-aqueous electrolyte batteries 20 shown in FIG. 1 and FIG. 2 described above. These plural secondary batteries 20 are arranged so as to be adjacent to each other in one direction. The positive electrode terminals 13 and negative electrode terminals 11 of these secondary batteries 20 are connected in series to each other by connecting leads 21 to 24 formed of Cu. A positive electrode drain lead 25 is connected to the positive electrode terminal 13 of the secondary battery 20 shown on the left end and a negative electrode drain lead 26 is connected to the negative electrode terminal 11 of the secondary battery 20 shown on the right end.

In the flat type non-aqueous electrolyte battery according to this embodiment, as described above, the negative electrode lead is electrically connected to the negative electrode terminal with the conductive film interposed therebetween, the conductive film being capable of melting when the conductive film is heated to or beyond a temperature of the melting point thereof by an electric current flowing through the conductive film. Therefore, as described above, an over electric current flows towards the negative electrode lead through the conductive film from the negative electrode terminal, the conductive film is heated by Joule heat which is generated an interface between the negative electrode terminal and the conductive film and an interface between the conductive film and the negative electrode lead. If, the heating temperature of the conductive film becomes equal to or beyond its melting point, the conductive film is melded. Consequently, the connection between the negative electrode lead and the negative electrode terminal is cut off, so that the electric current flow between the lead and the terminal is interrupted. As a result, a rise in the internal temperature of the metal container is rapidly suppressed.

In a preferable embodiment, since the Sn alloy film containing Sn and at least one metal selected from the group consisting of Zn, Pb, Ag, Cu, In, Ga, Bi, Sb, Mg and Al has a lower melting point of 180 to 220° C., the Sn alloy film is easily melted by the Joule heat generated at the Sn alloy film as described above.

In the non-aqueous electrolyte secondary battery provided with a mechanism that interrupts the current flowing across the negative electrode lead and the negative electrode terminal, a micronization of a conductive film such as the Sn alloy film, which is interposed between the negative electrode lead and the negative electrode terminal, by an alloying reaction with lithium can be suppressed by using the negative electrode containing an active material which absorbs lithium ions at a potential higher by 0.4 V or more than the electrode potential of lithium. Therefore, a low resistance connection and high reliability of connection between the negative electrode lead and the negative electrode terminal can be retained for a long period of time.

Also, since the phenomenon of micronization caused by an alloying reaction with lithium can be suppressed by using the negative electrode containing an active material which absorbs lithium ions at a specified potential even if a current collector, lead and terminal around the negative electrode are made from low resistance aluminum (or aluminum alloy), these members can be connected with a low resistance.

Accordingly, a non-aqueous electrolyte secondary battery which has a current-breaking mechanism having a simple structure, is smaller-sized and produced at a lower cost than conventional batteries having a protective circuit, has such high reliability as to suppress the development of short circuits at the connecting part between the negative electrode lead and the negative electrode terminal even if it is vibrated or receives an impact, and is superior in large-current characteristics due to low-resistance connection between the current collector, lead and terminal around the negative electrode, can be provided.

Moreover, a combined battery having high safety and reliability can be provided by connecting and combining two or more of the square-shaped non-aqueous electrolyte secondary batteries having the characteristics.

The present invention will be described hereinbelow, by way of examples with reference to the drawings. However, the present invention is not limited to the examples described below and various modifications are possible within the spirit of the present invention.

### Example 1

<Production of a Negative Electrode>

Using lithium titanate (Li₄Ti₅O₁₂) having an average particle diameter of primary particles of 0.5 μm and specific surface area of BET using N₂ gas of 20 m²/g as an active material, a carbon powder having an average particle diameter of 4 μm as a conductive agent and a polyvinylidene fluoride (PVdF) as a binder, these components were formulated in a ratio by weight of 90:7:3 and dispersed in an n-methylpyrrolidone (NMP) solvent to prepare a slurry. This slurry was applied to an aluminum alloy foil (current collector) having an average crystal particle diameter of 50 μm, an aluminum purity of 99% and a thickness of 15 μm, dried and pressed, followed by cutting to produce 83 negative electrodes having dimensions of 55 m×86 mm and an electrode density of 2.4 g/cm^{3.} A lead formed of a 5 mm-wide, 30 mm-long and 20 μm-thick aluminum foil having a purity of 99.9% was bound with one end of each current collector of the negative electrodes by ultrasonic welding.

### <Production of a Positive Electrode>

Using a spinel type lithium-manganese oxide (LiMn₂O₄) as an active material, a graphite powder as a conductive agent and a polyvinylidene fluoride (PVdF) as a binder, these components were formulated in a ratio by weight of 87:8:5 and dispersed in n-methylpyrrolidone (NMP) solvent to prepare a slurry. This slurry was applied to an aluminum alloy foil (current collector) having an average crystal particle diameter of 10 μm, an aluminum purity of 99% and a thickness of 15 μm, dried and pressed, followed by cutting to produce 84 positive electrodes having dimensions of 56 mm×87 mm and an electrode density of 2.9 g/cm³. A lead formed of a 5 mm-wide, 30 mm-long and 20 μm-thick aluminum foil having purity of 99.9% was bound with one end of each current collector of the positive electrodes by ultrasonic welding.

<Production of a Lid>

A lid was prepared, having dimensions of about 62 mm (length)×about 13 mm (width)×0.5 mm (thickness), from which cylindrical positive electrode terminals were integrally projected. The lid and positive electrode terminals were made of an aluminum alloy containing 1.6% by weight of Mg, 1% by weight of Mn and 0.4% by weight of Fe, which was substantially balanced with Al. A hole for supporting the negative electrode terminal was opened apart from the positive electrode terminals in this lid. A cylindrical insulation member provided with a disk-like jaw portion on each end was engaged in the hole. A bolt-like negative electrode terminal with the head portion having a diameter of 5 mm was inserted into the cylindrical insulation member of the lid and the screw portion on the side opposite to the head portion was made to project from the lid. A nut made of an aluminum alloy was screw-fitted to the projected screw portion via a washer made of an aluminum alloy to secure the negative electrode terminal to the lid via the cylindrical insulation member. The negative electrode terminal was made of an aluminum alloy containing 1% by weight of Mg, 0.6% by weight of Si and 0.25% by weight of Cu, which was substantially balanced with Al. The above nut and washer were made of an aluminum alloy containing 1% by weight of Mg, 0.6% by weight of Si and 0.25% by weight of Cu, which was substantially balanced with Al.

<Fabrication of a Secondary Battery>

The above-mentioned 83 negative electrodes to which the leads were bound and above-mentioned 84 positive electrodes to which the leads were bound were alternately inserted between bent parts of a separator made of 25 μm-thick unwoven fabric of cellulose folded in a zigzag manner and laminated. The end part of the separator was wound so as to cover the outside peripheral surface of the rectangular cylindrical laminate to produce an electrode group 5 as shown in FIG. 3. This flattened wound electrode group was further subjected to press molding. The leads connected to each negative electrode of the flattened wound electrode group were tied up in a bundle and an Sn alloy foil was sandwiched between the end of the bundle and the underside of the head portion of the negative electrode terminal of the lid to bind the tied leads with the negative electrode terminal with the Sn alloy foil being interposed therebetween by ultrasonic welding. The top of the lead connected to each positive electrode of the flattened wound electrode group was united on the surface of the lid positioned just below the positive electrode terminal and welded to that surface. As the Sn alloy foil, an Sn alloy foil having a composition of Sn, 8 wt % of Zn, and 3 wt % of Bi, a melting point of about 200° C. and a thickness of 50 μm was used. A non-aqueous electrolyte solution prepared by dissolving 1.5 mol/L of LiBF₄ in a mixed solution of ethylene carbonate (EC) and γ-butyrolactone (GBL) (volume ratio: 1:2) was poured into a bottomed rectangular cylinder (rectangular metal can).

This metal can was made of an aluminum alloy containing 1.6% by weight of Mg, 1% by weight of Mn and 0.4% by weight of Fe, which was substantially balanced with Al and had dimensions of 95 mm (height)×62 mm (length)×13 mm (width) and a wall thickness of 0.4 mm. In succession, the flattened wound electrode group was inserted into the metal can, and the lid connected in advance to the flattened wound electrode group, though the lead was engaged in the opening of the metal can and the outer periphery of the lid was bound with the opening of the metal can by laser welding, thereby to fabricate a 95 mm-high, 62 mm-long and 13 mm-wide square-shaped non-aqueous electrolyte secondary battery having a discharge capacity of 4 Ah as shown in FIGS. 1 and 2. The internal resistance of this secondary battery was 1.5 mΩ when expressed as 1 kHz AC impedance.

### Examples 2 to 7

A square-shaped non-aqueous electrolyte secondary battery was produced, having the same structure as Example 1 except that an Sn alloy foil and In alloy foil as shown in Table 1 below were interposed between the negative electrode lead and a negative electrode terminal having a composition as shown in Table 1 was used.

### Example 8

Five square-shaped non-aqueous electrolyte secondary batteries which were the same types as Example 1 were prepared. These secondary batteries were connected in parallel with each other by copper connecting leads to produce a combined battery.

### Comparative Examples 1 to 5

A square-shaped non-aqueous electrolyte secondary battery was produced having the same structure as Example 1 except that a metal foil as shown in Table 1 below was interposed or not imposed between the negative electrode lead and the negative electrode terminal having the composition shown in Table 1.

### Comparative Example 6

Five square-shaped non-aqueous electrolyte secondary batteries of the same types as Comparative Example 1 were prepared. These secondary batteries were connected in parallel with each other by copper connecting leads to produce a combined battery.

The obtained square-shaped non-aqueous electrolyte secondary batteries obtained in Examples 1 to 7 and Comparative Examples 1 to 5 and the combined batteries obtained in Example 8 and Comparative Example 6 were each connected to a 5 mΩ external resistance to make an external short-circuit test, thereby measuring the maximum temperature of the surface in the center of the battery. The results are shown in Table 1.

TABLE 1

| | Conductive film interposed | | The maximum |
|---|---|---|---|
| | between the negative | | temperature |
| | electrode lead and the | | of the surface in the |
| | negative electrode | Negative electrode terminal: | center of the battery |
| | terminal: the numerals in | the numerals in the | when external short- |
| | the parenthesis show wt % | parenthesis show wt % | circuit occurs |
| Example 1 | Sn(89)Zn(8)Bi(3)alloy | Al(98.15)Mg(1)Si(0.6)Cu(0.25) | 110° C. |
| Example 2 | Sn(90)Pb(10)alloy | Al(98.15)Mg(1)Si(0.6)Cu(0.25) | 105° C. |
| Example 3 | Sn(90)In(10)alloy | Al(98.15)Mg(1)Si(0.6)Cu(0.25) | 100° C. |
| Example 4 | Sn(90)Ag(8)Cu(2)alloy | Cu | 120° C. |
| Example 5 | Sn(90)Zn(8)Al(2)alloy | Ni | 115° C. |
| Example 6 | Sn(90)Pb(8)Sb(2)alloy | Fe(74)—Ni(8)—Cr(18) | 105° C. |
| Example 7 | In(90)Zn(10)alloy | Al(98.15)Mg(1)Si(0.6)Cu(0.25) | 105° C. |
| Example 8 | Sn(89)Zn(8)Bi(3)alloy | Al(98.15)Mg(1)Si(0.6)Cu(0.25) | 130° C. |
| (combined battery) | | | |
| Comparative Example 1 | None | Al(98.15)Mg(1)Si(0.6)Cu(0.25) | 170° C. |
| Comparative Example 2 | Zn | Al(98.15)Mg(1)Si(0.6)Cu(0.25) | 180° C. |
| Comparative Example 3 | Pb | Al(98.15)Mg(1)Si(0.6)Cu(0.25) | 175° C. |
| Comparative Example 4 | Sn | Al(98.15)Mg(1)Si(0.6)Cu(0.25) | 180° C. |
| Comparative Example 5 | Ni | Cu | 185° C. |
| Comparative Example 6 | None | Ni | 240° C. |
| (combined battery) | | | |

As is clear from above Table 1, it is understood that, in the external short-circuit test, the square-shaped non-aqueous electrolyte secondary batteries of Examples 1 to 7 in which an Sn alloy foil or In alloy foil is interposed between the negative electrode lead and the negative electrode terminal to connect the negative electrode lead with the negative electrode terminal each have the characteristics that the maximum surface temperature in the center thereof is 120° C. or less, which is lower than that of each of the square-shaped non-aqueous electrolyte secondary batteries obtained in Comparative Examples 1 to 5, and are unchanged in shape, showing that these secondary batteries of the present invention are superior in external short-circuit performance. The combined battery of Example 8 is obtained by combining two or more of the square-shaped non-aqueous electrolyte secondary batteries in which an Sn alloy foil is interposed between the negative electrode lead and the negative electrode terminal to connect the negative electrode lead with the negative electrode terminal in the same manner as described above. The combined battery of Example 8 has the characteristics that the maximum surface temperature in the center thereof is 130° C. or less, which is lower than that of the combined battery obtained in Comparative Example 6, and are unchanged in shape, showing that the combined battery of the present invention is superior in external short-circuit performance. This is because in the square-shaped non-aqueous electrolyte secondary batteries of Examples 1 to 7, the Sn alloy foil or In alloy foil interposed between the negative electrode lead and the negative electrode terminal were melted, leading to the breakdown of electrical connection. The secondary batteries obtained in Comparative Examples 1 to 5 and the combined battery of Comparative Example 6 all exhibited significant swelling of the metal container.

What is claimed is:

1. A non-aqueous electrolyte secondary battery comprising:
a metal container;
an electrode group housed in the metal container and comprising a positive electrode, a negative electrode having an active material which absorbs lithium ions at a potential higher by 0.4 V or more than the electrode potential of lithium and a separator interposed between the negative electrode and the positive electrode;
a non-aqueous electrolyte housed in the metal container;
a positive electrode lead of which one end is electrically connected to the positive electrode;
a negative electrode lead of which one end is electrically connected to the negative electrode;
a positive electrode terminal attached to the metal container and being electrically connected with the other end of the positive electrode lead;
a negative electrode terminal attached to the metal container and being electrically connected with the other end of the negative electrode lead; and
a conductive film interposed between the negative electrode lead and the negative electrode terminal,
wherein the conductive film is capable of melting when the conductive film is heated to or beyond a temperature of a melting point thereof by an electric current flowing through the conductive film.

2. The secondary battery of claim 1, wherein the negative electrode lead and the negative electrode terminal are made of aluminum or an aluminum alloy, respectively.

3. The secondary battery of claim 1, wherein the negative electrode terminal is attached and electrically insulated to the metal container and the positive electrode terminal is electrically connected to the metal container.

4. The secondary battery of claim 1, wherein the other end of the positive electrode lead is electrically connected to the metal container which serves as the positive electrode terminal.

5. The secondary battery of claim 1, wherein the metal container is made of an aluminum alloy containing at least one metal selected from Mg, Mn and Fe.

6. The secondary battery of claim 1, wherein the active material of the negative electrode is a titanium-containing metal oxide.

7. The secondary battery of claim 1, wherein the active material of the positive electrode is a composite oxide selected from the group consisting of a lithium-manganese composite oxide, a lithium-nickel composite oxide, a lithium-cobalt composite oxide, a lithium-nickel-cobalt composite oxide, a spinel type lithium-manganese-nickel composite oxide, a lithium-manganese-cobalt composite oxide, lithium ironphosphate and a lithium-nickel-cobalt-manganese composite oxide having a layer crystal structure.

8. A non-aqueous electrolyte secondary battery comprising:
a metal container;
an electrode group housed in the metal container and comprising a positive electrode, a negative electrode having an active material which absorbs lithium ions at a potential higher by 0.4 V or more than the electrode potential of lithium and a separator interposed between the negative electrode and the positive electrode;
a non-aqueous electrolyte housed in the metal container;
a positive electrode lead of which one end is electrically connected to the positive electrode;
a negative electrode lead of which one end is electrically connected to the negative electrode;
a positive electrode terminal attached to the metal container and being electrically connected with the other end of the positive electrode lead;
a negative electrode terminal attached to the metal container and electrically connected with the other end of the negative electrode lead; and
an Sn alloy film interposed between the negative electrode lead and the negative electrode terminal, wherein the Sn alloy film comprises Sn and at least one metal selected from the group consisting of Zn, Pb, Ag, Cu, In, Ga, Bi, Sb, Mg and Al.

9. The secondary battery of claim 8, wherein the negative electrode lead and the negative electrode terminal are made of aluminum or an aluminum alloy.

10. The secondary battery of claim 8, wherein the negative electrode terminal is attached and electrically insulated to the metal container and the positive electrode terminal is attached and electrically connected to the metal container.

11. The secondary battery of claim 8, wherein the other end of the positive electrode lead is electrically connected to the metal container which serves as the positive electrode terminal.

12. The secondary battery of claim 8, wherein the metal container is made of an aluminum alloy containing at least one metal selected from the group consisting of Mg, Mn and Fe.

13. The secondary battery of claim 8, wherein the active material of the negative electrode is a titanium-containing metal oxide.

14. The secondary battery of claim 8, wherein the active material of the positive electrode is a composite oxide selected from the group consisting of a lithium-manganese composite oxide, a lithium-nickel composite oxide, a lithium-cobalt composite oxide, a lithium-nickel-cobalt composite oxide, a spinel type lithium-manganese-nickel composite oxide, a lithium-manganese-cobalt composite oxide, lithium ironphosphate and a lithium-nickel-cobalt-manganese composite oxide having a laminate crystal structure.

15. The secondary battery of claim 8, wherein the Sn alloy film comprises Sn in an amount of 70 to 95% by weight and the at least one metal in an amount of 5 to 30% by weight.

16. The secondary battery of claim 8, wherein the Sn alloy film is an Sn alloy foil comprising Sn and at least one metal selected from the group consisting of Zn, Pb, Ag, Cu, In, Ga, Bi, Sb, Mg and Al, and the negative electrode lead and the negative electrode terminal are bound each other with the Sn alloy foil which is interposed between the negative electrode lead and the negative electrode terminal.

17. The secondary battery of claim 8, wherein the Sn alloy film is formed in either a portion of the negative electrode lead to which the negative electrode terminal is connected or a portion of the negative electrode terminal to which the negative electrode lead is connected, or both of the portions.

18. A combined battery comprising a plurality of the non-aqueous electrolyte secondary batteries each defined in claim 1, the batteries being electrically connected with each other in series, in parallel, or in series and parallel.

19. A combined battery comprising a plurality of the non-aqueous electrolyte secondary batteries each defined in claim 8, the batteries being electrically connected with each other in series, in parallel, or in series and parallel.
